(19) United States
(12) Patent Application Publication
(10) Pub. No.: US 2026/0093077 A1
(43) Pub. Date: Apr. 2, 2026

(54) PACKAGE FOR ENCAPSULATING A PHOTONIC INTEGRATED CIRCUIT (PIC)

(71) Applicant: TECHNISCHE UNIVERSITEIT EINDHOVEN, EINDHOVEN (NL)

(72) Inventors: Oded RAZ, EINDHOVEN (NL); Marc SPIEGELBERG, EINDHOVEN (NL)

(21) Appl. No.: 19/113,232

(22) PCT Filed: Sep. 21, 2023
(86) PCT No.: PCT/NL2023/050490

§ 371 Date: Mar. 19, 2025

(30) Foreign Application Priority Data
Sep. 21, 2022 (NL) 2033090

(51) Int. Cl. G02B 6/42

(52) U.S. Cl. CPC G02B 6/4214; G02B 6/4257

(57) ABSTRACT

A package for encapsulating a photonic integrated circuit, PIC, the package comprising:
a cavity for receiving the PIC, the cavity defined by interior walls of the package;
a light propagating portion made of a semiconductor material comprising a light inlet, a light outlet and a light reflecting surface,
   the light inlet formed by an interior wall of the package that faces a light outlet of the PIC, said interior wall arranged at a semi-perpendicular angle with respect to light exiting the PIC, to allow said light to enter into the light propagating portion of the package,
   the light reflecting surface arranged at a transverse angle with respect to the propagation direction of the light exiting the PIC so that the light reflecting surface reflects incoming light towards the light outlet;
   the light outlet formed by an outer surface of the package.

### TECHNICAL FIELD

The present disclosure generally relates to the field of photonic integrated circuits (PICs) and more in particular to the field of sealing such PICs in a package, while providing both electrical and optical connectivity.

### BACKGROUND

Photonic integrated circuits (PICs) often require hermetically sealed packaging including high speed electrical signalling (input and output, I/O) ports as well as optical input and output ports. These requirements of hermetic sealing, electrical I/O ports and optical I/O ports lead to advanced and complicated packaging, including so-called gold-box packages. These current packages are suboptimal as they are highly complex to make and it is time consuming to assemble the packaging and the PIC.

In particular, present packages rely on epoxy secured fibers, e.g. lensed fibres to provide the optical input and output functionality. For example U.S. Pat. No. 9,874,688B2 relates to co-packaging for photonic integrated circuits in which optical fibers are used to provide optical input and output functionality.

A disadvantage of the use of these fibres is that they need to be actively aligned to the PIC with a sub-micrometer tolerance. This process is time consuming, leading to problems in scaling up to use PIC technology on a world-wide scale.

As such, it is an object of the present disclosure to provide a packaging which solves at least one of the above-mentioned problems, at least partially.

### SUMMARY

Accordingly the present disclosure provides for a package for encapsulating a photonic integrated circuit, PIC, the package comprising:
a cavity for receiving the PIC, the cavity defined by interior walls of the package;
a light propagating portion made of a semiconductor material and comprising a light inlet, a light outlet and a light reflecting surface, wherein:
   the light inlet is formed by an interior wall of the package that faces a light outlet of the PIC, light entering into the light propagating portion of the package through said inlet,
   the light reflecting surface is arranged at a transverse angle with respect to the propagation direction of the light exiting the PIC, the light reflecting surface reflecting incoming light towards the light outlet; and
   the light outlet is formed by an outer surface of the package.

Advantageously the light propagating portion, having the light inlet, the reflecting surface at a transverse angle and the light outlet as defined in the above allows that light can be sent towards/emitted from the PIC through the package itself, without needing to rely on optical fibers to transport the light from the PIC facet to the outside of the package and, preferably, with the light traveling through air for only a short distance and instead traveling through the material of the package where it scatters less-provided the right packaging material is chosen, as is explained in the below. This is seen as a break-through in the field of packages for PICs since with this principle the use of optical fibers inside the “gold box” may be omitted. This is especially advantageous for optical wireless systems or Lidar modules. This may lead to very significant improvements in package assembly time, package costs and package complexity, which are all reduced compared to prior art solutions. It should be understood that, obviously, optical fibers may be connected to the package itself, at the outside thereof.

The specific orientation of the interior package wall with respect to the light outlet of the PIC may vary a bit depending on the material that is chosen for the light propagating portion. In general, most semiconductor materials will allow light to enter when they are arranged substantially perpendicular to the light outlet of the PIC, e.g. at an angle of in between 85 and 95 degrees, more in particular at an angle of in between 88 and 92 degrees. The specific orientation depends on the total internal reflection characteristics of the material. Having learn about the technical principle as described herein, a person skilled in the art will be able to select a proper orientation for each suitable material.

In an alternative embodiment, the interior wall of the package that defines the light inlet is arranged at an angle of in between −35 and −55 degrees with respect to light exiting the PIC. The light will also be able to enter the package material with an inlet arranged at an angle, although the light beam will be bent. However, when the reflective surface and the inlet wall are arranged at suitable angles, the light will still be able to exit the package. From a manufacturing point of view, an interior wall arranged at an angle of in between −35 and −55 degrees may be preferred, as such wall orientations may be easier to obtain than substantially straight walls. This may however depend on the material that is selected for the package.

Advantageously, once the light is inside the material, it is the high internal refractive index of the material which allow the guiding of the light beam towards an outlet, without the need to especially treat the light reflecting surface once it is arranged at the transverse angle.

As will be described in the below, the word “towards” means that the light should be reflected by the light reflective surface in the direction of the light outlet, but this may be in an indirect manner, e.g. by steering the light towards a second reflecting surface which sends the light towards the light outlet.

In an embodiment of the disclosure, the interior package wall that defines the light inlet and/or the outer package surface that defines the light outlet are coated with an anti-reflective surface. Such a coating will make it more easy to allow the light to enter into the semiconducting material.

In an embodiment of the disclosure, the semiconductor material comprises silicon or is silicon. It has been found by the inventors that especially silicon can be etched particularly well while forming an angled surface—i.e. the light reflecting surface. Additionally, because silicon has a relatively high refractive index, once the light has entered the silicon material beam divergence in the material is relatively slow so that the light can be sent through a relatively thick layer of silicon/via a relatively long path through the silicon without diverging the light beam beyond repair. Furthermore, silicon is an excellent heat conductor so that heat generated in the PIC/package due to high speed electronic signalling may be dissipated efficiently. Finally, silicon is very stiff/robust, so that a wafer with a thickness of less than 0.3 mm may suffice while still providing sufficient mechanical strength. Importantly, the divergence of a light beam when traveling through a 0.3 mm thick silicon wafer while being reflected by a reflected surface is small enough to reliably define the light outlet.

In an embodiment of the present disclosure the package comprises a bottom portion and a top portion that are mounted on top of each other. For example, some material may be removed from both the top and the bottom portion to define the cavity of the package. Several sealing techniques are known to one skilled in the art to mount a top and bottom portion to provide a package that is hermetically sealed once closed, the present disclosure not being limited to a particular one of these mounting techniques. Advantageously, when the package comprises a bottom portion and a top portion it will in general be easy to place the PIC in the package, although some calibration will still be needed to optimally integrate the PIC and the package.

In an embodiment of the present disclosure the top portion of the package comprises the light propagating portion, the light propagating portion optionally being an integral part of the top portion. In such an embodiment, in particular the entire top portion may be made of a silicon material. In such an embodiment, the light outlet may be defined at the outer top surface of the package, which may be convenient for further processing of the light beam.

In alternative embodiments the part of the package that contains the light inlet and the reflective surface may be a separate part that can be attached to the part of the package that contains the light outlet. For example, the attaching can be effected through the use of a suitable adhesive. When the part of the package that contains the light inlet, light reflective surface and the light outlet is formed as an assembly—i.e. comprising at least two components that are assembled to each other—it may be possible to use less thick wafers for the manufacturing of the package, such that the packages can be made faster and with less material, so that a substantially cheaper package may be obtained. It should be noted that in choosing the adhesive and assembling the parts one must ensure that the light path of the light travelling through the package is not interfered with too much. The skilled person will be able to select such adhesives.

In an embodiment of the present disclosure the bottom portion comprises through silicon via's for providing electrical connectivity to the PIC. A through silicon via is deemed known to one skilled in the art and may be formed of some metal, e.g. applied on a silicon substrate. Through the metal, electrons can flow towards and away from the PIC, providing the said electrical connectivity e.g. in the form of an electrical inlet port and an electrical outlet port.

In an embodiment of the present disclosure, both the top and the bottom portion of the package are made of a silicon wafer. In particular, in such an embodiment the bottom wafer may include the through silicon vias and the top wafer may include the light propagating portion. As described in the above, the portion of the package through which the light travels may be integrally made, or it may be assembled from two or more parts. It has already been described why it is advantageous to make the light propagating portion of silicon. A particular advantage of making both the top and bottom portion of the package of silicon wafers is that such wafers are readily available, commonly known in the chip industry and that many processing techniques of silicon wafers are known; in part stemming from other technical field. A lot of knowledge is out there on how to etch and coat silicon wafers, knowledge which may be relied upon to optimally form the package as described herein—e.g. to form the anti-reflective coatings and to form the through silicon vias.

In an embodiment of the present disclosure, each of the top and bottom portion of the package comprises a metal layer at the sealing location, the portions being sealed to each other via a metal-on-metal compression sealing. Advantageously, in this way a hermetic sealing of the package may be obtained easily and efficiently. However, this sealing technique is only one of many that may be used to hermetically seal the package.

In an embodiment of the present disclosure, a metal layer is disposed on an interior wall of the bottom portion, the metal layer providing electrical connectivity to the PIC. This embodiment may be implementing in addition to using through silicon vias, or as an alternative to using through silicon vias.

In an embodiment of the present disclosure, the outer surface of the package, at the position of the light outlet, is arranged substantially horizontally, so that light exits the package substantially vertically. It may be possible to place a lens or other light-deflecting object near the light outlet, but this is of course entirely up to the specific application in which the PIC package is used. In an embodiment where the light exits the PIC substantially horizontally, this may mean that a single light reflective surface as part of the light propagating portion may suffice.

In an embodiment of the present disclosure, the outer surface of the package, at the position of the light outlet, is arranged substantially vertically, so that light exits the package substantially horizontally. It may be possible to place a lens or other light-deflecting object near the light outlet, but this is of course entirely up to the specific application in which the PIC package is used. In an embodiment where the light exits the PIC substantially horizontally, this may mean that two light reflective surface may be included in the light propagating portion.

In an embodiment of the present disclosure, an angle of the light reflective surface, compared to the orientation of the PIC in the cavity, is in between 35 and 55 degree, and in particular is about 45 degrees or 54.7 degrees. Especially when silicon wafers are used to manufacture the package, it may be very easy to process the wafer and obtain a surface having the specified orientation of 45 or 54.7 degrees.

In particular, when a light reflective surface is arranged at 45 degrees, the light inlet wall may be arranged at either-54.7 degrees or at 90 degrees. When the light reflective surface is however arranged at 54.7 degrees, and the wall inlet is arranged at 90 degrees, the light may not be able to travel towards the light outlet. Hence, in such an embodiment both package walls are preferably arranged at 54.7 degrees the light reflective surface at +54.7 degrees and the inlet wall at −54.7 degrees from the axis defined by the light leaving the PIC. From a manufacturing perspective, when the package is made of a silicon material, walls arranged at plus or minus 54.7 (54.6) degrees may be easier to make than walls arranged at 45 degrees.

In an embodiment of the present disclosure, the light reflective surface is straight. Using etching techniques a very precise straight angled surface may be defined on the silicon wafer.

As an alternative, the light reflective surface may be curved, in particular convex, so that the light beam is converged towards the outlet. It is noted that a curved surface may be more challenging to manufacture with the same precision.

These and other aspects of the present disclosure will now be described with reference to the attached figures. In said figures, same of like elements have been denominated with the same reference numerals. In the figure:

### BRIEF DESCRIPTION OF THE FIGURES

FIG. 1 schematically shows, in a cross sectional view, a first embodiment of a PIC package in accordance with the present disclosure;

FIG. 2 schematically shows, in a cross sectional view, a detail of FIG. 1;

FIG. 3 schematically shows, in a cross sectional view, a second embodiment of a PIC package in accordance with the present disclosure; and

FIGS. 4A-4F schematically show various alternative PIC packages in accordance with the present disclosure.

FIGS. 5A-5C schematically show further alternative PIC packages in accordance with the present disclosure.

### DETAILED DESCRIPTION OF THE FIGURES

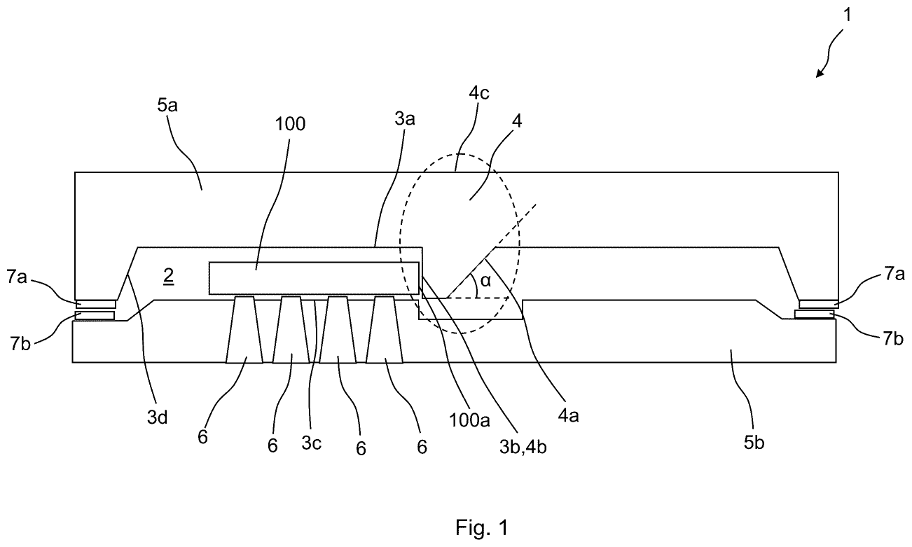

With reference to FIG. 1 initially, shown is a package 1 for a photonic integrated circuit, PIC, 100. As shown, the package 1 includes interior walls 3a, 3b, 3c, 3d which define a cavity 2. The PIC 100 is placed inside the cavity 2, while the package 1 is sealed. More details on the sealing of the package 1 will be described in the below.

The package 1 is made entirely out of silicon, or possibly another semiconductor material. The package 1 as shown here comprises a bottom portion 5b and a top portion 5a which are sealed to each other via seals 7a, 7b. Each of the bottom portion 5b and top portion 5a is made of silicon material, and may e.g. be manufactured from a silicon wafer.

As shown, the bottom portion 5b includes so-called through silicon via's 6, which may be created by etching out silicon material from the wafer so that a hole or aperture is formed, and depositing a metal inside the etched-away hole, the metal material bonded to the silicon material of the bottom portion 5b and extending from the outside of the package 1 towards the interior wall 3c of the package. The through silicon via's 6 may be in contact with the PIC 100, although this is not shown for reasons of clarity, to provide electrical signalling to said PIC 100, e.g. in the form of input and output signals. The bottom portion 5b furthermore comprises a metal layer 7b along both ends. Again, the metal layer 7b may e.g. placed on the wafer that defines the bottom portion 5b of the package 1 by etching away some of the silicon and plating the edge with the metal.

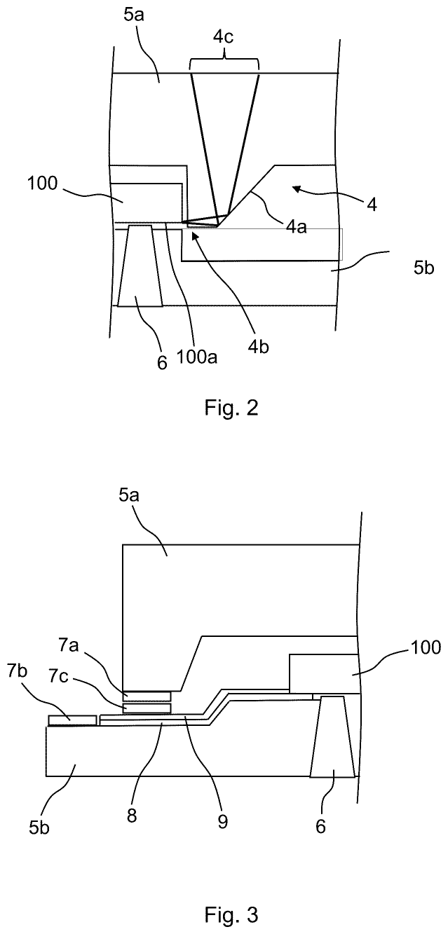

The top portion 5a as shown here includes a light propagating portion 4, the details of which are described in the below in more detail with reference to FIG. 2, and a further metal layer 7a at an edge position of the top portion 5a opposite of the metal layer 7b of the bottom portion (when the top 5a and bottom 5b portion are placed on top of each other). Once the PIC 100 is inserted in the cavity, the top 5a and bottom 5b portion may be pressed on top of each other, possibly with some vibration, and a metal-on-metal compression sealing may be obtained to hermetically seal the package 1. Note how the light propagating portion 4 is integrally formed with the rest of the top portion 5a, and is thus also made of a silicon material.

Whereas the PIC obtains electrical signalling via the through silicon vias 6, the PIC 100 obviously also requires an optical input/output to function. As such, the package 1 must ensure this optical input/output signals to be passed to and from the PIC 100 respectively. This is where the light propagating portion 4 comes into play.

Turning now to FIG. 2 as well, the light propagating portion 4, that is here an integral part of the package 1 top portion 5a, is shown in more detail. The light propagating portion 4 comprises a light inlet 4b, a light reflecting surface 4a and a light outlet 4c. Note how the light inlet 4b is defined by an interior wall 3b of the top portion 5a and how the light outlet 4c is defined by an outer surface of the top portion 5a. The light inlet 4b is here arranged perpendicular to the light that exits the PIC 100, so that the light can straightly enter into the light propagating portion 4 and is not reflected by it. The same goes for the light outlet 4c, which is also arranged substantially perpendicular to the light in the light propagating portion 4 near the outlet 4c, so that light is not reflected by the outer surface 5a but may rather travel through the silicon-air boundary out of the package. Both these inlet 4b and outlet 4c can be coated with an anti-reflective coating so that light may pass this edge of the package 1 without being reflected by the silicon material more easily compared to an uncoated surface.

In more detail, the light is emitted from the PIC 100 at PIC light outlet 100a. The light travels through the cavity 2 (which may be filled with air, an inert gas and/or with may be at an absolute or relative vacuum) and hits the interior wall 3b of the package 1. Note that the travel distance through the cavity 2 is minimized by arranging the interior wall 3b of the package 1 close to the light outlet 100a of the PIC 100. The interior wall 3b is here arranged at a semi-perpendicular angle with respect to light exiting the PIC and it defines a light inlet 4b through which the light enters into the material of the package. The light travels through the material and diverges. However, as the material is silicon the divergence of the light beam is moderately and within controllable ranges.

As the light propagates through the package 1 material, it hits a second surface, the light reflective surface 4a. This surface may be uncoated when it is silicon; due to the total internal reflection characteristics of silicon and the specific angle a at which the surface is oriented, said angle α being e.g. in between 45° and 54.7°, in particular 45° as shown here, it will reflect the light beam and send it towards the upper surface of the package 1, which may define the light outlet 4c as here. Note that the light reflective surface 4a here is defined as a straight surface, arranged at a constant angle with respect to the horizontal/the orientation in which the PIC 100 is mounted in this case.

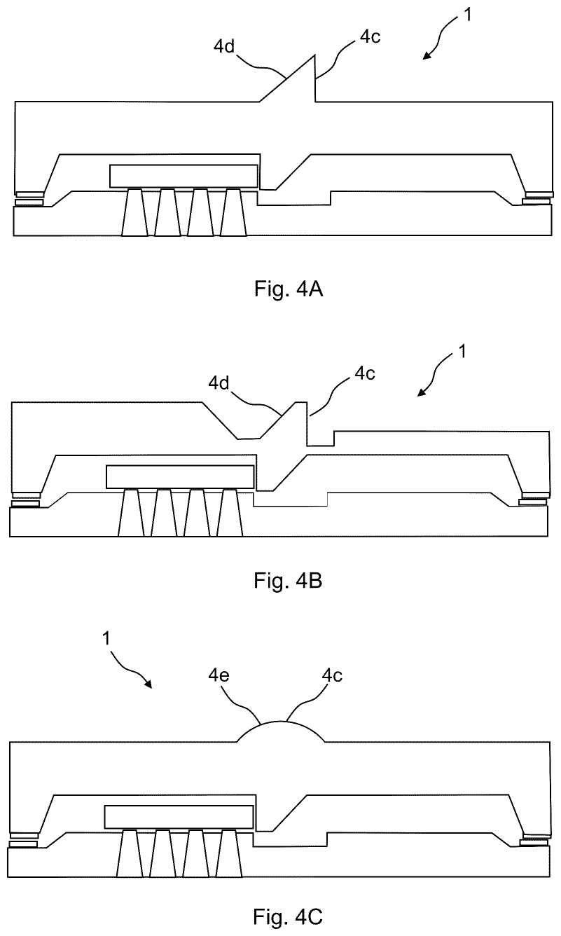

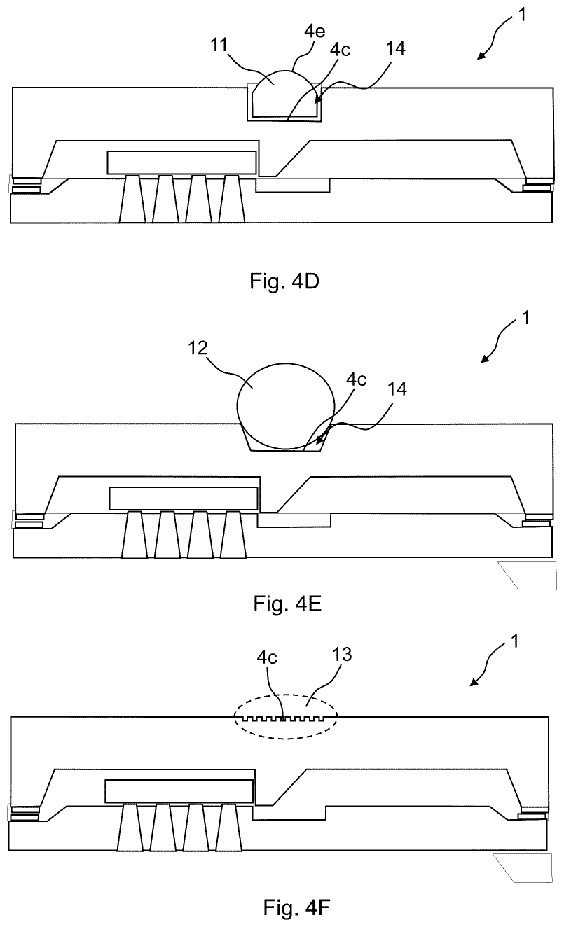

When the light then finally hits the outer surface of the package 1, which is here also coated with an anti-reflective coating and defines a light outlet 4c, the light may exit from the silicon material and a package 1 is obtained through which optical output may be realized without relying on optical fibre tubes. In the shown embodiment, the outer surface of the package 1 is arranged substantially horizontally, so that the light exits the package substantially vertically. Other implementations are however conceivable, as is e.g. shown in the below with reference to FIGS. 4A-4F.

It goes without saying that optical input may be guided towards the PIC 100 in substantially the same way as the way in which light may be outputted, at a different location by utilizing the same features of a light inlet and outlet by coated package surfaces and a light reflective surface e.g. by untreated package surface arranged at an angle.

Turning now to FIG. 3, an alternative and/or additional way to get electronical signalling towards the PIC 100 is shown. It is noted that this feature of an isolated metal layer provided on the bottom of the cavity may be realized independently of the above-described way in which optical input and output may be guided through the package, and may e.g. be implemented together with optical tubes for optical input/output or with other technologies to input/output light between the circuit and the packaging.

Shown in FIG. 3 is a layer of metal 8, e.g. gold or copper, applied on the bottom portion 5a of the package 1 in ways that are known to one skilled in the art. The metal layer 8 is isolated by applying a further layer 9 on top of it, e.g. a layer of silicon dioxide SiO₂. On top of the isolating layer 9 a further sealing contact 7c is provided. Through the metal layer 8, which extends from the edge of the package 1 all the way to the PIC 100, it may be possible to send electronic signalling towards the PIC 100 without resorting to through silicon vias 6. However, as shown the isolated metal layer 8 may alternatively be used in conjunction with such through silicon vias 6 as well.

Turning now to FIGS. 4A-4F , further alternative embodiments are shown, wherein the outer surface of the package 1 is modified at the position of the light outlet 4c compared to the embodiments of FIGS. 1 and 2, to modify the light beam exiting the packaging.

Schematically shown in FIG. 4A is a second light reflective surface 4d upon which the light will hit after being deflected by the first light reflective surface. The second light reflective surface 4d, in this particular embodiment arranged at an angle of substantially 45 degrees, will alter the direction of the light beam for a second time, towards a generally horizontal orientation. In the embodiment of FIG. 4A, again the light outlet 4c may be coated with an anti-reflective coating but in contrast to the embodiments shown in relation to FIGS. 1 and 2 the light outlet 4c is arranged generally vertically instead of horizontally.

Turning now to FIG. 4B, compared to FIG. 4A this is a more efficient solution to achieve the same result of implementing a second light reflective surface 4d and guiding the light beam towards the horizontal direction. In particular, instead of the second light reflective surface 4d extending with respect to the remainder of the package (as is the case in FIG. 4A), in the embodiment shown in FIG. 4B the second light reflective surface 4d is etched into the package 1. Compared to the schematic implementation of FIG. 4A where the second reflective surface 4d extends from the package 1, the embodiment of FIG. 4B where the second light reflective surface 4d is etched into the package 1 uses a much less thick wafer-leading to significant cost saving.

Turning now to FIG. 4C, here a silicon lens 4e is integrated in the top surface of the package 1 where the light exit 4c is defined. The lens 4e may converge the light beam again, leading to a more focussed light beam that may be more useful for application arranged “behind” the PIC/its package.

Turning now to FIG. 4D, compared to FIG. 4C a more economic arrangement is shown which lead to the same results. Here a silicon lens 11, a component that is available off-the-shelf, is placed in an aperture 14 that is created in the top portion of the package 1. The solution of FIG. 4D may advantageously be achieved with much less silicon material being etched away compared to the solution shown and described in relation to FIG. 4C.

Shown in FIGS. 4E and 4F respectively are further lens-like solutions for further manipulation of the light beam exiting the package at the light outlet 4C. In the case of FIG. 4E an aperture 14 is again created in the top portion of the package 1, a cylinder 12 in this embodiment being integrated in the package top portion so that the light exiting the package 1 may be guided in a direction that points into and out of the paper by the cylinder. In the case of FIG. 4F a grating structure 13 including concentric circles, shown in cross-section, is integrated in the top surface of the package to more precisely steer the direction in which the light travels when exiting the package through the light outlet 4c.

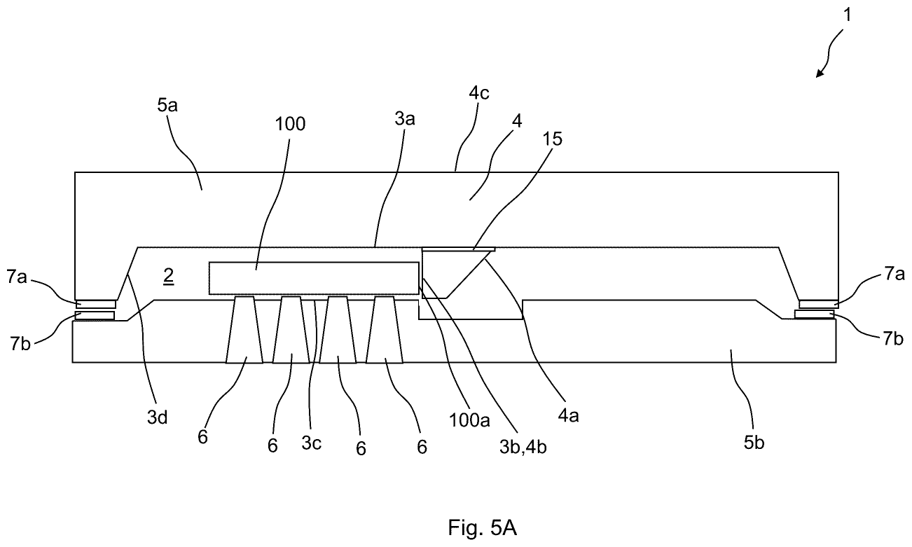

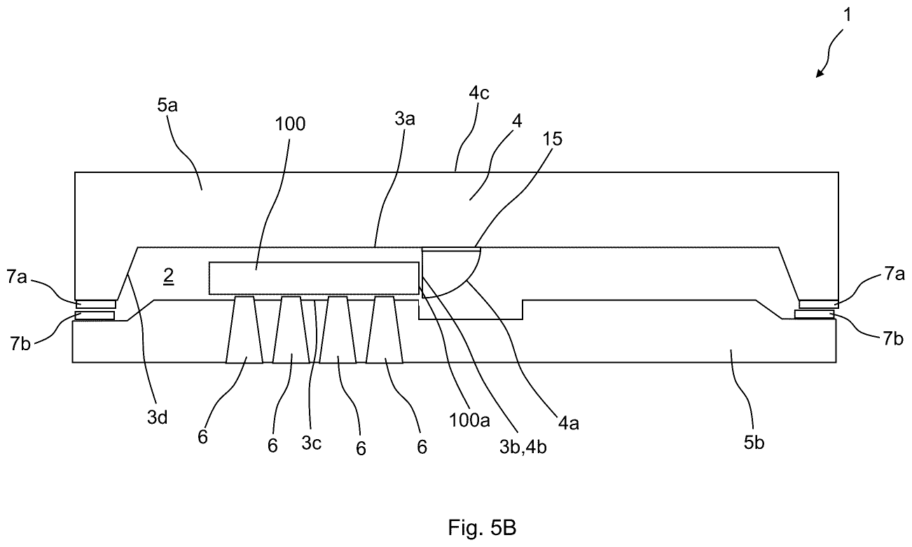

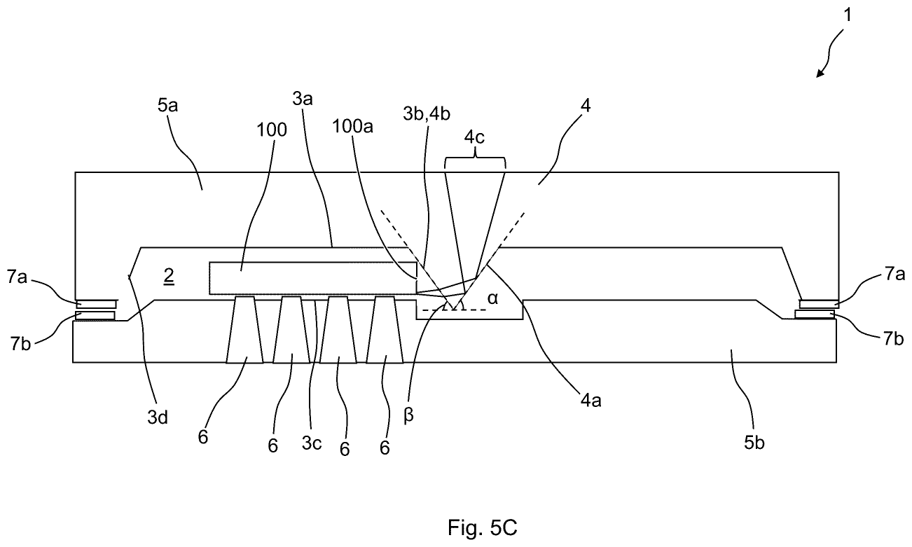

Further alternative embodiments of the package 1 are shown in FIGS. 5A-5C.

FIG. 5A shows a package 1 design which is highly similar to the design shown in FIG. 1, except for the fact that here the top portion 4 is made out of two parts and is formed as an assembly. The part of the top portion 4 which constitutes the light inlet 4b and the light reflective surface 4a is made as a separate component, which is attached to the rest of the top portion 4 with an adhesive layer 15. Such a design works essentially the same as the embodiment of FIG. 1 from a technical perspective, but may have advantages from a manufacturing perspective. It is mainly the light inlet 4b and the light reflective surface 4a which need to be made with high precision, so that process parameters need to be controlled with this high precision only on a smaller part, and a less thick wafer may be used.

FIG. 5B shows a package 1 design that is highly similar to the embodiment of FIG. 5A, except for the fact that here the light reflective surface is formed by a convex surface. Even though light beam divergence is kept within acceptable limits when the package is made of silicon, making the reflective surface convex may narrow the light beam compared to making it straight. This opens the door to a higher degree of control of the light beam exit position, as well as to other materials to be used as packaging material.

FIG. 5C, finally, shows a package design which is again highly similar compared to the design of FIG. 2, except for the fact that the light inlet wall 4b is arranged at an angle β of −54.7 degrees and the light reflective surface 4a is arranged at an angle a of 54.7 degrees. Also with this geometry the light exits the package, while walls having an angle of plus or minus 54.7 degrees may be easier to make that walls having angles of 90 degrees or 45 degrees.

### ALTERNATIVE EMBODIMENTS

1. A package for encapsulating a photonic integrated circuit, PIC, the package comprising:
   a cavity for receiving the PIC, the cavity defined by interior walls of the package;
   a light propagating portion made of a semiconductor material and comprising a light inlet, a light outlet and a light reflecting surface, wherein:
      the light inlet is formed by an interior wall of the package that faces a light outlet of the PIC, said interior wall arranged at a semi-perpendicular angle with respect to light exiting the PIC, to allow said light to enter into the light propagating portion of the package,
      the light reflecting surface is arranged at a transverse angle with respect to the propagation direction of the light exiting the PIC so that the light reflecting surface reflects incoming light towards the light outlet; and
      the light outlet is formed by an outer surface of the package.
2. The package according to embodiment 1, wherein the interior wall of the package that defines the light inlet is arranged at an angle of in between 85 and 95 degrees, in particular in between 88 and 92 with respect to light exiting the PIC.
3. The package according to embodiment 1 or 2, wherein the interior package wall that defines the light inlet and/or the outer package surface that defines the light outlet are coated with an anti-reflective surface.
4. The package according to any one of the preceding embodiments, wherein the semiconductor material comprises silicon or is silicon.
5. The package according to any one of the preceding embodiments, wherein the package comprises a bottom portion and a top portion that are mounted to each other.
6. The package according to embodiment 5, wherein the top portion of the package comprises the light propagating portion, the light propagating portion preferably being an integral part of the top portion.
7. The package according to embodiment 5 or 6, wherein the bottom portion comprises through silicon via's for providing electrical connectivity to the PIC.
8. The package according to any one of the embodiments 5-7, wherein both the top and the bottom portion of the package are made of a silicon wafer.
9. The package according to any one of the embodiments 5-8, wherein each of the top and bottom portion of the package comprises a metal layer at the sealing location, the portions being sealed to each other via a metal-on-metal compression sealing.
10. The package according to any one of the preceding embodiments, wherein a metal layer is disposed on an interior wall of the bottom portion, the metal layer providing electrical connectivity to the PIC.
11. The package according to any one of the preceding embodiments, wherein the outer surface of the package, at the position of the light outlet, is arranged substantially horizontally, so that light exits the package substantially vertically.
12. The package according to any one of the embodiments 1-10, wherein the outer surface of the package, at the position of the light outlet, is arranged substantially vertically, so that light exits the package substantially horizontally.
13. The package according to any one of the preceding embodiments, wherein an angle of the light reflective surface, compared to the orientation of the PIC in the cavity, is in between 35 and 55 degree, and in particular is about 45 degrees or 54.7 degrees.
14. The package according to any one of the preceding embodiments, wherein the light reflective surface is straight.
15. The package according to any one of the preceding embodiments wherein a lens, e.g. made of silicon, is integrated in the package at the position where the light outlet is defined.
16. The package according to any one of the preceding embodiments, wherein the package comprises an aperture at the light exit, a lens or cylinder being arranged in said aperture, the lens or cylinder preferably being made of silicon.
17. The package according to any one of the preceding embodiments, wherein a grating structure, comprising a plurality of concentric circles, is created in the package at the position where the light outlet is defined.

1. A package for encapsulating a photonic integrated circuit, PIC, the package comprising:
a cavity for receiving the PIC, the cavity defined by interior walls of the package;
a light propagating portion made of a semiconductor material and comprising a light inlet, a light outlet and a light reflecting surface, wherein:
the light inlet is formed by an interior wall of the package that faces a light outlet of the PIC, light entering into the light propagating portion of the package through said inlet,
the light reflecting surface is arranged at a transverse angle with respect to the propagation direction of the light exiting the PIC, the light reflecting surface reflecting incoming light towards the light outlet; and
the light outlet is formed by an outer surface of the package.

2. The package according to claim 1, wherein the interior wall of the package that defines the light inlet is arranged at a semi-perpendicular angle with respect to the light exiting the PIC, in particular an angle of in between 85 and 95 degrees, preferably in between 88 and 92.

3. The package according to claim 1, wherein the interior wall of the package that defines the light inlet is arranged at an angle of in between −35 and −55 degrees with respect to light exiting the PIC

4. The package according to claim 1, wherein the interior wall of the package that defines the light inlet and/or the outer package surface that defines the light outlet are coated with an anti-reflective surface.

5. The package according to claim 1, wherein the semiconductor material comprises silicon or is silicon.

6. The package according to claim 1, wherein the package comprises a bottom portion and a top portion that are mounted to each other.

7. The package according to claim 6, wherein the top portion of the package comprises the light propagating portion, the light propagating portion optionally being an integral part of the top portion.

8. The package according to claim 6, wherein the bottom portion comprises through silicon via's for providing electrical connectivity to the PIC.

9. The package according to claim 6, wherein both the top and the bottom portion of the package are made of a silicon wafer.

10. The package according to claim 6, wherein each of the top and bottom portion of the package comprises a metal layer at the sealing location, the portions being sealed to each other via a metal-on-metal compression sealing.

11. The package according to claim 6, wherein a metal layer is disposed on an interior wall of the bottom portion, the metal layer providing electrical connectivity to the PIC.

12. The package according to claim 1, wherein the outer surface of the package, at the position of the light outlet, is arranged substantially horizontally, so that light exits the package substantially vertically.

13. The package according to claim 1, wherein the outer surface of the package, at the position of the light outlet, is arranged substantially vertically, so that light exits the package substantially horizontally.

14. The package according to claim 1, wherein an angle of the light reflective surface, compared to the orientation of the PIC in the cavity, is in between 35 and 55 degree, and in particular is about 45 degrees or 54.7 degrees.

15. The package according to claim 1, wherein the light reflective surface is straight or convex.

16. The package according to claim 1, wherein a lens, e.g. made of silicon, is integrated in the package at the position where the light outlet is defined.

17. The package according to claim 1, wherein the package comprises an aperture at the light exit, a lens or cylinder being arranged in said aperture, the lens or cylinder preferably being made of silicon.

18. The package according to claim 1, wherein a grating structure, comprising a plurality of concentric circles, is created in the package at the position where the light outlet is defined.
